(19) United States
(12) Patent Application Publication
(10) Pub. No.: US 2024/0175850 A1
(43) Pub. Date: May 30, 2024

(54) DATA PROCESSING SYSTEM

(71) Applicant: SHIMADZU CORPORATION, Kyoto (JP)

(72) Inventor: Tomohiro KAWASE, Kyoto (JP)

(73) Assignee: SHIMADZU CORPORATION, Kyoto (JP)

(21) Appl. No.: 18/204,413

(22) Filed: Jun. 1, 2023

(30) Foreign Application Priority Data
Jul. 19, 2022 (JP) 2022-114804

(51) Int. Cl. G01N 30/86

(52) U.S. Cl. CPC G01N 30/8631

(57) ABSTRACT

A data processing system (1) including a data holder (8) that holds analysis data including mass spectrometry data acquired by a mass spectrometer (100) in an analysis of a sample using a chromatograph mass spectrometer and measurement data acquired by a detector, that is not mass spectrometer, in the analysis of the sample, a data processor (10) configured to perform data processing by using the analysis data held in the data holder (8), and an information displayer (12) configured to display data processed by the data processor (10). The data processor (10) is configured to create a chromatogram based on the measurement data, and identify a peak portion in which peaks of a plurality of components overlap to form one peak shape among peak portions on the chromatogram as a coelution peak by using a correspondence relationship between the chromatogram and the mass spectrometry data, and when displaying the chromatogram, the information displayer (12) is configured to display a peak portion identified as the coelution peak by the data processor (10) in a mode different from that of another peak portion.

### BACKGROUND OF THE INVENTION

### 1. Field of the Invention

The present invention relates to a data processing system that performs data processing using analysis data obtained by a chromatograph mass spectrometer.

### 2. Description of the Related Art

In a chromatograph such as a liquid chromatograph or a gas chromatograph, in order to develop an analysis method (combination of conditions such as a separation column to be used, a mobile phase, and a flow rate of a mobile phase) optimal for analysis of a target sample, operation of performing analysis a plurality of times using various analysis methods, and comparing analysis data obtained in each piece of analysis is compared to search for an analysis method that can separate a component in the target sample in a most excellent manner is performed.

Depending on an analysis method, what is called coelution, in which a plurality of components in a sample are eluted from a separation column in a state of not being completely separated from each other, may occur. When coelution occurs, peaks of a plurality of components overlap on a chromatogram to form one peak shape (hereinafter, referred to as a coelution peak). For this reason, it is necessary to evaluate experimental data obtained by analysis by each analysis method by checking whether or not a portion forming a peak shape (hereinafter, referred to as a peak portion) on a chromatogram is a coelution peak.

Here, WO 2020/194582 A discloses that analysis data of a chromatograph mass spectrometer including a detector other than a mass spectrometer such as a photodiode array (PDA) detector and a mass spectrometer downstream of a separation column is used to add information obtained from mass spectrometry data to a chromatogram obtained from measurement data of the detector. According to the disclosed technique, information such as that a component having what mass-to-charge ratio is eluted can be added to a chromatogram, so that the user can check whether or not each peak on the chromatogram is a coelution peak by referring to the additional information.

### SUMMARY OF THE INVENTION

In method development, it is necessary to select a method with excellent separation performance while referring to a large number of chromatograms obtained for the same sample. At that time, even if additional information extracted from mass spectrometry data is added to a chromatogram, it is necessary for the user to check whether or not each peak portion of each chromatogram is a coelution peak with reference to the additional information, and it is not considered to be easy for the user to visually recognize which chromatogram shows excellent separation.

The present invention has been made in view of the above problem, and an object of the present invention is to enable the user to easily recognize whether or not each peak portion on a chromatogram is of coelution.

A data processing system according to the present invention is a data processing system including a data holder that holds analysis data including mass spectrometry data acquired by a mass spectrometer in an analysis of a sample by using a chromatograph mass spectrometer and measurement data acquired by a detector, that is not mass spectrometer, in the analysis of the sample, a data processor configured to perform data processing by using the analysis data held in the data holder, and an information displayer configured to display data processed by the data processor. The data processor is configured to create a chromatogram based on the measurement data, and to identify a peak portion in which peaks of a plurality of components overlap to form one peak shape among peak portions on the chromatogram as a coelution peak by using a correspondence relationship between the chromatogram and the mass spectrometry data, and when displaying the chromatogram, the information displayer is configured to display a peak portion identified as the coelution peak by the data processor in a mode different from that of another peak portion, thus allowing a user to visually recognize whether or not each peak portion on the chromatogram is the coelution peak.

According to the data processing system according to the present invention, a coelution peak is identified using a chromatogram based on measurement data acquired by a detector and mass spectrometry data acquired by a mass spectrometer, and when a chromatogram is displayed, a peak portion identified as a coelution peak is displayed in a mode different from that of another peak portion, so that the user is allowed to visually recognize whether or not each peak portion is a coelution peak. Therefore, the user can easily recognize whether or not each peak on the chromatogram is of coelution.

### BRIEF DESCRIPTION OF THE DRAWINGS

FIG. 1 is a block diagram illustrating an embodiment of a data processing system;

FIG. 2 is a flowchart showing an example of operation when a chromatogram is displayed in the embodiment;

FIG. 3 is a flowchart showing an example of operation when a peak is designated on a chromatogram;

FIG. 4 is an example of a chromatogram displayed on a display;

FIG. 5 is an example of a screen when a coelution peak is designated on a chromatogram; and

FIG. 6 is an example of a screen on which a peak table is displayed.

### DETAILED DESCRIPTION OF THE INVENTION

Hereinafter, an embodiment of a data processing system according to the present invention will be described with reference to the accompanying drawings.

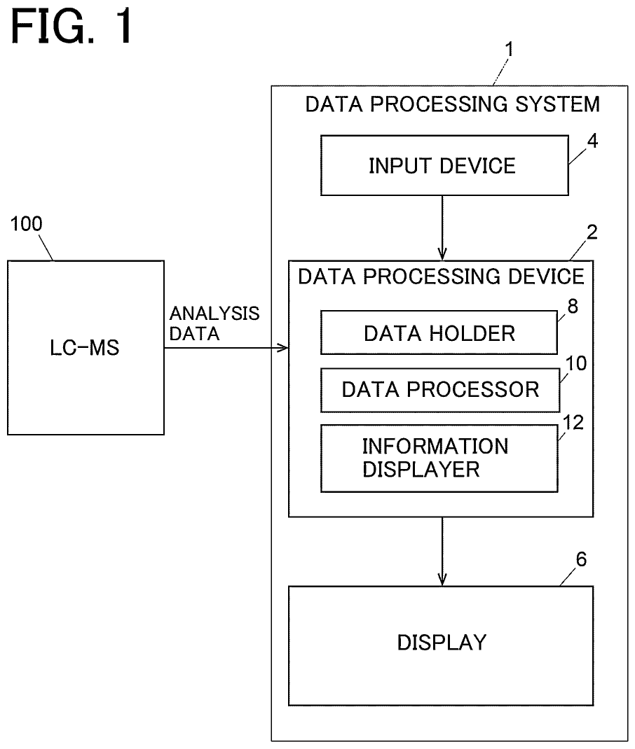

As illustrated in FIG. 1, a data processing system 1 includes a data processing device 2, an input device 4, and a display 6. The data processing device 2 is realized by a computer device such as a personal computer into which a dedicated program is introduced. The input device 4 is realized by a keyboard and/or a mouse and the like communicably connected to the data processing device 2. The user can input information to the data processing device 2 via the input device 4. The display 6 is communicably connected to the data processing device 2 and displays information output from the data processing device 2.

The data processing device 2 includes a data holder 8, a data processor 10, and an information displayer 12. Analysis data acquired by analysis of a sample by a liquid chromatograph mass spectrometer 100 (hereinafter referred to as LC-MS 100) is taken into the data processing device 2, and the analysis data that is taken in is held in the data holder 8.

The LC-MS 100 includes a detector (for example, a UV detector) other than a mass spectrometer provided downstream of a separation column, and a mass spectrometer provided downstream of the detector. In the detector of LC-MS 100, measurement data showing a relationship between elution time (retention time) from a separation column and signal intensity corresponding to component concentration in eluate from the separation column is obtained. In the mass spectrometer of the LC-MS 100, scan data at regular time intervals indicating a relationship between a mass-to-charge ratio (m/z) of a component in eluate having passed through the detector and signal intensity corresponding to a component amount is obtained as mass spectrometry data. The data holder 8 holds measurement data acquired by the detector and mass spectrometry data acquired by the mass spectrometer. The data holder 8 is realized by a partial storage area of a data storage device provided in the data processing device 2.

The data processor 10 is configured to execute data processing of analysis data held in the data holder 8. Details of the data processing executed by the data processor 10 will be described later. The data processor 10 is a function obtained by a central processing unit (CPU) provided in the data processing device 2 executing a program.

The information displayer 12 is configured to display data processed by the data processor 10 on the display 6. The information displayer 12 is also a function obtained by a CPU provided in the data processing device 2 executing a program.

When displaying a chromatogram created based on measurement data obtained by the detector of the LC-MS 100 on the display 6, the data processing system 1 of the present embodiment shows a peak portion that is a coelution peak in a mode different from that of another peak portion so that the user can visually recognize whether or not a peak portion (a portion where a waveform has a peak shape) appearing in the chromatogram is a coelution peak. The coelution peak is a peak portion in which peaks of a plurality of components overlap each other to form one peak shape. Whether or not each peak portion on a chromatogram is a coelution peak can be determined, for example, using a method disclosed in WO 2020/194582 A.

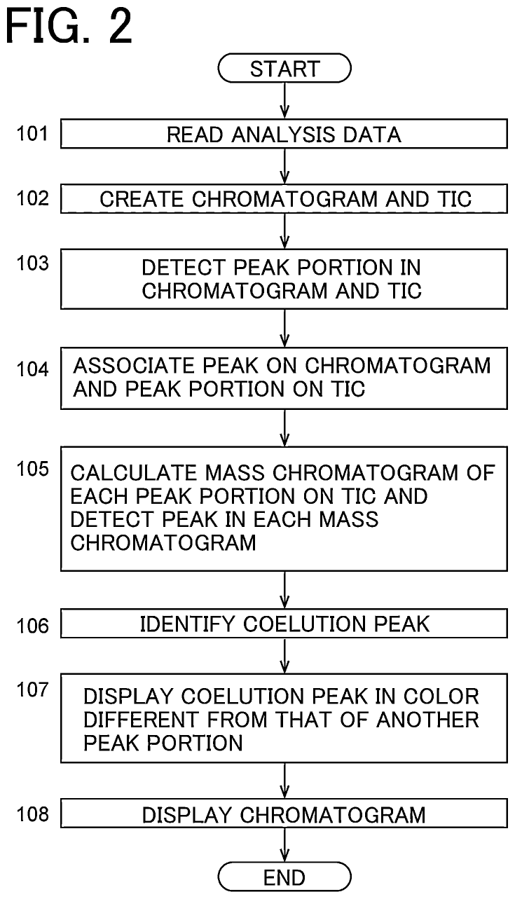

Hereinafter, an example of data processing operation related to display of a chromatogram will be described with reference to a flowchart of FIG. 2.

First, the data processor 10 reads target analysis data (Step 101). The data processor 10 creates a chromatogram using measurement data obtained by the detector, and creates a total ion chromatogram (TIC) by summing intensities of ions detected during one time of mass scanning using mass spectrometry data obtained by the mass spectrometer (Step 102).

Next, the data processor 10 detects a peak portion forming a peak-like waveform in each of the chromatogram and the TIC (Step 103). For the detection of a peak portion, a method of detecting a peak start point, a peak top, and a peak end point based on a slope of the chromatogram or the like can be used. After a peak portion is detected in each of the chromatogram and the TIC, the data processor 10 associates the peak portion on the chromatogram with the peak portion on the TIC in consideration of delay time until a component that passes through the detector flows into the mass spectrometer (Step 104). For example, delay time is subtracted from elution time of the TIC, and peaks in which elution time of the peak portion on the chromatogram and elution time of the peak portion on the TIC are substantially the same are associated with each other.

Next, the data processor 10 calculates a mass chromatogram within a range from a start point to an end point of each peak portion on the TIC, and detects a peak included in each peak portion on the TIC (Step 105). After the above, the data processor 10 compares peak top retention time of a mass chromatogram in which a peak is detected for each peak portion to determine the number of components included in each peak portion on the TIC. When the number of components contained in each peak portion is determined, if a difference in peak retention time between mass chromatograms falls within a certain range, the mass chromatograms are determined to be of the same component, and the mass chromatograms between which a difference in peak top retention time exceeds the certain range are determined to be of different components. When a plurality of components are included in a single peak portion, the data processor 10 determines that coelution occurs, and identifies the peak portion as a coelution peak (Step 106).

In a process of the above processing, a mass chromatogram of a component included in each peak portion is extracted by the data processor 10 and stored in a predetermined data storage area. In a case where there are a plurality of mass chromatograms for the same component, a mass chromatogram having a mass-to-charge ratio with maximum signal intensity is extracted as a mass chromatogram of the component.

For example, when displaying a chromatogram on the display 6 in accordance with a request from the user, the information displayer 12 displays a peak portion identified as a coelution peak by the data processor 10 in a color different from that of another peak portion (Step 107), and displays a chromatogram in a state in which the user can visually identify a peak portion that is a coelution peak and a peak portion that is not a coelution peak on the display 6 (Step 108).

FIG. 4 is an example of a chromatogram displayed on the display 6 in a state where a peak portion identified as a coelution peak and a peak portion other than a coelution peak in different colors. In this example, a color is applied only to the peak portion specified as a coelution peak, and it is obvious at a glance whether or not a coelution peak exists and which peak portion is a coelution peak.

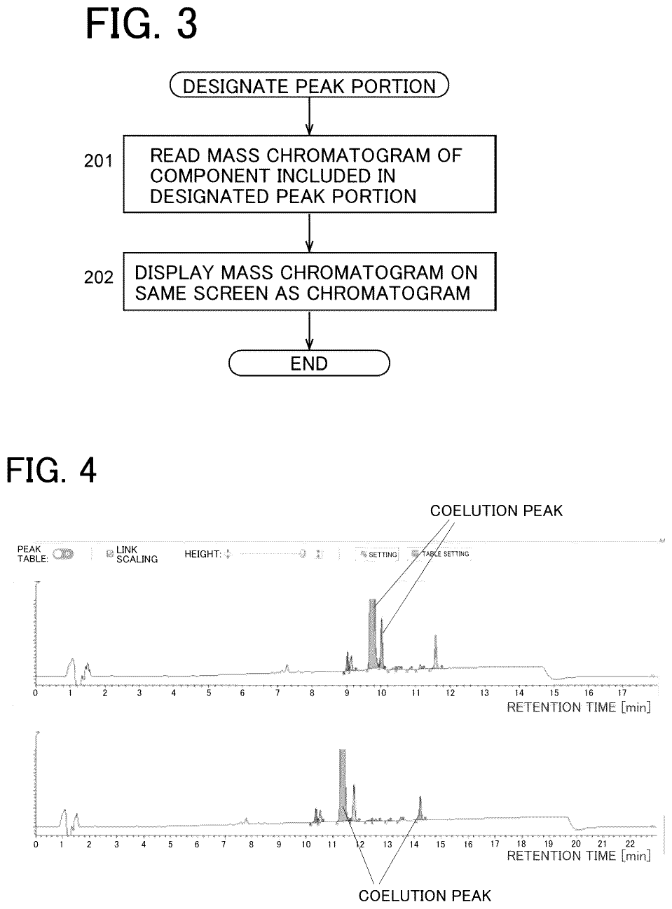

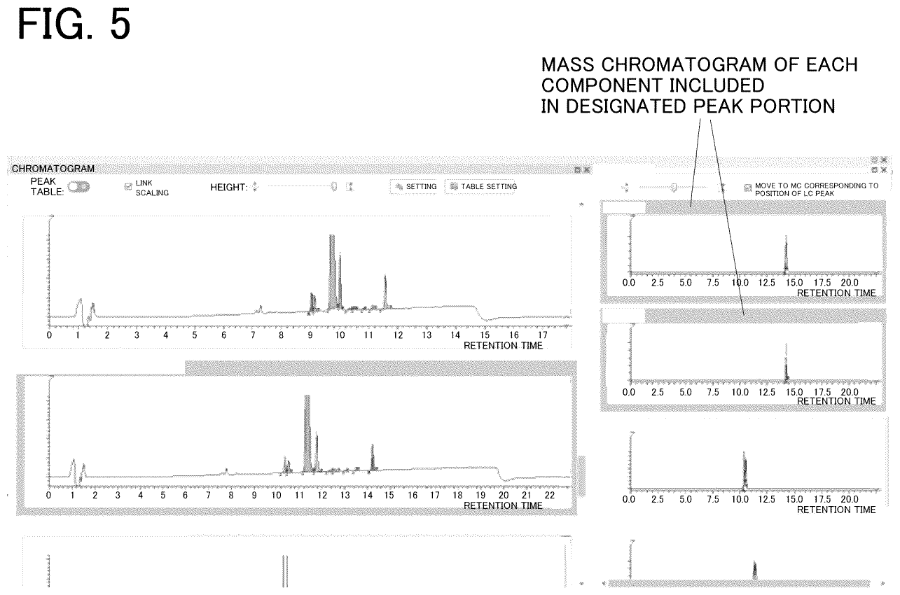

Further, as illustrated in FIG. 3, when an optional peak portion is designated on a mass chromatogram displayed on the display 6, the information displayer 12 reads a mass chromatogram of a component included in the designated peak portion from a predetermined data storage area (Step 201), and displays the read mass chromatogram on the same screen as the chromatogram (Step 202). In a case where the user designates a coelution peak, as illustrated in FIG. 5, a mass chromatogram of each of a plurality of components included in the coelution peak is displayed. The mass chromatogram displayed on the same screen as the chromatogram also shows a mass-to-charge ratio of the component. By the above, the user can easily check a component having what mass-to-charge ratio is coeluted.

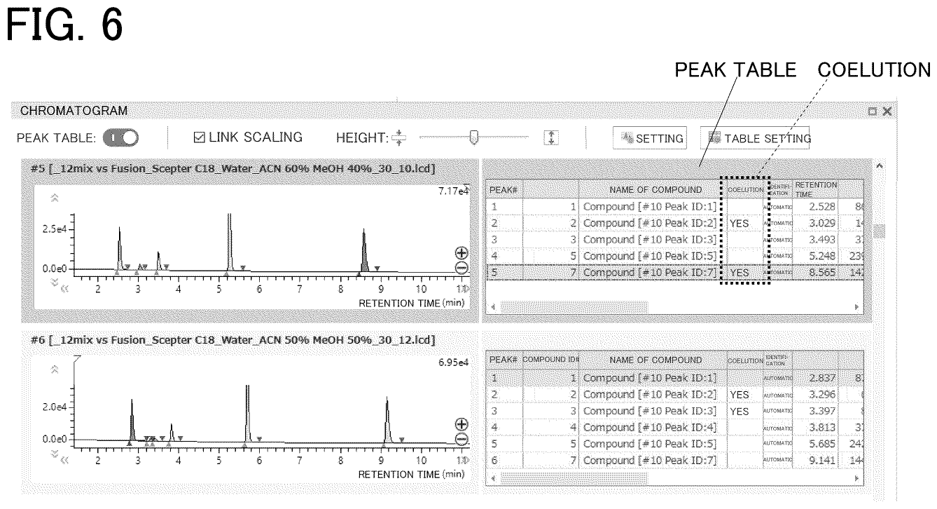

Further, the data processor 10 has a function of creating a peak table showing information on each peak portion on a chromatogram in a list, and the information displayer 12 has a function of displaying a peak table created by the data processor 10 on the display 6 in accordance with a request from the user. FIG. 6 is an example of the peak table displayed on the display 6. Information shown in the peak table includes information on whether or not each peak portion on a chromatogram is a coelution peak. By the above, the user can easily obtain information such as whether or not a chromatogram includes a coelution peak and which peak portion is a coelution peak not only from a color difference on the chromatogram but also from the peak table.

Further, the data holder 8 can hold a plurality of pieces of analysis data obtained using analysis methods different from each other for the same component. In this case, the data processor 10 can create a plurality of chromatograms for each analysis method using a plurality of pieces of analysis data for the same component held in the data holder 8, and execute peak identification of associating peaks appearing in a plurality of the chromatograms with each other. In the peak identification, one of a plurality of the chromatograms is set as a reference chromatogram, and which peak on the reference chromatogram each peak on the other chromatograms corresponds to is identified. This peak identification can be performed using a peak area, a peak height, a peak area % (an area ratio of the peak to a total area of all peaks on the same chromatogram), a height % (a height ratio of the peak to a total height of all peaks on the same chromatogram), a peak No (place in elution order), a similarity of a UV spectrum, a similarity of a mass spectrum, a mass-to-charge ratio of a base peak of a mass spectrum, and the like. The user may be able to optionally set whether or not to include a coelution peak as a target of such peak identification. In this case, when the user sets a coelution peak to be excluded from a target of peak identification, the data processor 10 excludes a coelution peak from a target of peak identification.

Note that the embodiment described above merely illustrates an embodiment of the data processing system according to the present invention. The embodiment of the data processing system according to the present invention is as described below.

An embodiment of a data processing system according to the present invention is a data processing system including a data holder that holds analysis data including mass spectrometry data acquired by a mass spectrometer in an analysis of a sample using a chromatograph mass spectrometer and measurement data acquired by a detector, that is not mass spectrometer, in the analysis of the sample, a data processor configured to perform data processing by using the analysis data held in the data holder, and an information displayer configured to display data processed by the data processor. The data processor is configured to create a chromatogram based on the measurement data, and to identify a peak portion in which peaks of a plurality of components overlap to form one peak shape among peak portions on the chromatogram as a coelution peak by using a correspondence relationship between the chromatogram and the mass spectrometry data, and when displaying the chromatogram, the information displayer is configured to display a peak portion identified as the coelution peak by the data processor in a mode different from that of another peak portion, thus allowing a user to visually recognize whether or not each peak portion on the chromatogram is the coelution peak.

In a first aspect of the embodiment, the information displayer is configured to give a color different from that of the other peak portion to a peak portion identified as the coelution peak as the different mode.

In a second aspect of the embodiment, the data processor is configured to extract a mass chromatogram of a component included in each peak portion on the chromatogram from the mass spectrometry data, and when the user designates a peak portion on the chromatogram, the information displayer is configured to display a mass chromatogram of a component included in the designated peak portion side by side with the chromatogram. This makes it possible to easily check a component having what mass-to-charge ratio is included in each peak portion on a chromatogram.

In a third aspect of the embodiment, the data processor is configured to create a peak table based on the analysis data, the peak table including peak information on each peak portion on the chromatogram, the peak information showing whether or not each peak portion is the coelution peak in a list, and the information displayer is configured to display the peak table created by the data processor based on a request from the user.

In a fourth aspect of the embodiment, the data holder holds a plurality of pieces of analysis data acquired by analysis performed by using a plurality of analysis methods different from each other for the same sample by using the chromatograph mass spectrometer, the data processor is configured to create a plurality of chromatograms based on each of a plurality of pieces of the analysis data, set any of a plurality of the chromatograms as a reference chromatogram, and execute peak identification for identifying whether a peak portion on a chromatogram other than the reference chromatogram among a plurality of the chromatograms corresponds to any peak portion on the reference chromatogram, whether or not to exclude a coelution peak from a target of the peak identification can be set by a user in advance, and in a case where excluding the coelution peak from a target of the peak identification is set in advance, the data processor is configured to exclude a peak portion identified as the coelution peak from a target of the peak identification.

### DESCRIPTION OF REFERENCE SIGNS

1: data processing system
2: data processing device
4: input device
6: display
8: data holder
10: data processor
12: information displayer
100: LC-MS

What is claimed is:

1. A data processing system comprising:
a data holder that holds analysis data including mass spectrometry data acquired by a mass spectrometer in an analysis of a sample using a chromatograph mass spectrometer and measurement data acquired by a detector, that is not mass spectrometer, in the analysis of the sample;
a data processor configured to perform data processing by using the analysis data held in the data holder; and
an information displayer configured to display data processed by the data processor,
wherein the data processor is configured to create a chromatogram based on the measurement data, and to identify a peak portion in which peaks of a plurality of components overlap to form one peak shape among peak portions on the chromatogram as a coelution peak by using a correspondence relationship between the chromatogram and the mass spectrometry data, and
when displaying the chromatogram, the information displayer is configured to display a peak portion identified as the coelution peak by the data processor in a mode different from that of another peak portion so that a user can visually recognize whether or not each peak portion on the chromatogram is the coelution peak.

2. The data processing system according to claim 1, wherein the information displayer is configured to give a color different from that of the other peak portion to a peak portion identified as the coelution peak as the different mode.

3. The data processing system according to claim 1, wherein
the data processor is configured to extract a mass chromatogram of a component included in each peak portion on the chromatogram from the mass spectrometry data, and
when a user designates a peak portion on the chromatogram, the information displayer is configured to display a mass chromatogram of a component included in the designated peak portion side by side with the chromatogram.

4. The data processing system according to claim 1, wherein
the data processor is configured to create a peak table based on the analysis data, the peak table including peak information on each peak portion on the chromatogram, the peak information showing whether or not each peak portion is the coelution peak in a list, and
the information displayer is configured to display the peak table created by the data processor based on a request from a user.

5. The data processing system according to claim 1, wherein
the data holder holds a plurality of pieces of analysis data acquired by analysis performed by using a plurality of analysis methods different from each other for a same sample by using the chromatograph mass spectrometer,
the data processor is configured to create a plurality of chromatograms based on each of the plurality of pieces of analysis data, set any of the plurality of chromatograms as a reference chromatogram, and execute peak identification for identifying whether a peak portion on a chromatogram other than the reference chromatogram among the plurality of chromatograms corresponds to any peak portion on the reference chromatogram,
whether or not to exclude a coelution peak from a target of the peak identification can be set by a user in advance, and
in a case where excluding the coelution peak from a target of the peak identification is set in advance, the data processor is configured to exclude a peak portion identified as the coelution peak from a target of the peak identification.
